(19) United States
(12) Patent Application Publication
(10) Pub. No.: US 2026/0038746 A1
(43) Pub. Date: Feb. 5, 2026

(54) CAPACITOR

(71) Applicant: Panasonic Intellectual Property Management Co., Ltd., Osaka (JP)

(72) Inventors: Fumiya KAMBAYASHI, Osaka (JP); Takashi SASAKI, Osaka (JP); Shinji TAKEOKA, Osaka (JP)

(21) Appl. No.: 19/099,962

(22) PCT Filed: Aug. 31, 2023
(86) PCT No.: PCT/JP2023/031728

§ 371 Date: Jan. 30, 2025

(30) Foreign Application Priority Data
Sep. 30, 2022 (JP) 2022-159066

(51) Int. Cl. H01G 9/07; H01G 9/042; H01G 9/15

(52) U.S. Cl. CPC H01G 9/07; H01G 9/042; H01G 9/15

(57) ABSTRACT

A capacitor includes an anode, a multilayer film, and a cathode stacked in this order. The multilayer film includes at least two insulator layers and at least one semiconductor layer, and the at least two insulator layers and the at least one semiconductor layer are alternately stacked. The at least two insulator layer include a first insulator layer in contact with the anode and a second insulator layer in contact with the cathode. The second insulator layer has a thickness less than a thickness of the first insulator layer.

### TECHNICAL FIELD

The present disclosure relates to capacitors and more specifically relates to a capacitor including two electrodes and an insulator between the two electrodes.

### BACKGROUND ART

Non-Patent Literature 1 discloses a layered structure including two electrodes and a multilayer film between the two electrodes, wherein the multilayer film includes layers made of HfO₂ and layers made of ZnO which are alternately stacked.

### CITATION LIST

### Non-Patent Literature

Non-Patent Literature 1: Qiannan Zhang et al. “Semiconducting ZnO effect on Maxwell-Wagner relaxation in HfO₂/ZnO nanolaminates fabricated by atomic layer deposition”, Journal of Physics D: Applied Physics, 47 505302(2014)

### SUMMARY OF INVENTION

A capacitor according to an aspect of the present disclosure includes an anode, a multilayer film, and a cathode stacked in this order. The multilayer film includes at least two insulator layers and at least one semiconductor layer, and the at least two insulator layers and the at least one semiconductor layer are alternately stacked. The at least two insulator layers include a first insulator layer in contact with the anode and a second insulator layer in contact with the cathode. The second insulator layer has a thickness less than a thickness of the first insulator layer.

The present disclosure can provide the capacitor including the multilayer film including the at least two insulator layers and the at least one semiconductor layer stacked one on top of another, wherein the capacitance of the capacitor can be suppressed from changing along with a frequency change.

### BRIEF DESCRIPTION OF DRAWINGS

FIG. 1A is a schematic sectional view of an example of a capacitor according to one embodiment of the present disclosure, and FIG. 1B is a schematic sectional view of an example of a capacitor according to another embodiment of the present disclosure;

FIG. 2A is a schematic sectional view of a step in a production method of the capacitor according to the one embodiment of the present disclosure, and FIG. 2B is a schematic sectional view of a step following the step of FIG. 2A in the production method of the capacitor;

FIG. 3A is a schematic sectional view of a step in the production method of the capacitor according to the one embodiment of the present disclosure, FIG. 3B is a schematic sectional view of a step following the step of FIG. 3A in the production method of the capacitor, FIG. 3C is a schematic sectional view of a step following the step of FIG. 3B in the production method of the capacitor, and FIG. 3D is a schematic sectional view of a step following the step of FIG. 3C in the production method of the capacitor;

FIG. 4 is a schematic sectional view of a step in the production method of the capacitor according to the one embodiment of the present disclosure;

FIG. 5 is a schematic sectional view of a step in the production method of the capacitor according to the one embodiment of the present disclosure;

FIG. 6A is a schematic sectional view of an evaluation circuit including the capacitor according to the one embodiment of the present disclosure, FIG. 6B is a schematic sectional view of an evaluation circuit including a capacitor according to another embodiment of the present disclosure, and FIG. 6C is a schematic sectional view of an evaluation circuit including a capacitor according to another embodiment of the present disclosure;

FIG. 7A is a schematic sectional view of a capacitor according to a variation of the present disclosure, and FIG. 7B is a schematic sectional view of a multilayer film included in the capacitor according to the variation of the present disclosure;

FIG. 8A is an example of a graph illustrating voltage and current density relationships of the capacitor according to the one embodiment of the present disclosure, and FIG. 8B is another example of the graph illustrating the voltage and current density relationships of the capacitor according to the one embodiment of the present disclosure;

FIG. 9 is a graph illustrating the relationship between the capacitance of the capacitor according to the one embodiment of the present disclosure and a measurement frequency;

FIG. 10 is a graph illustrating the relationship between the capacitance of a capacitor according to another embodiment of the present disclosure and a measurement frequency; and

FIG. 11 is a graph illustrating the relationship between the capacitance of a capacitor according to another embodiment of the present disclosure and a measurement frequency.

### DESCRIPTION OF EMBODIMENTS

It is an object of the present disclosure to provide a capacitor including a multilayer film including at least two insulator layers and at least one semiconductor layer stacked one on top of another, wherein the capacitance of the capacitor can be suppressed from changing along with a frequency change.

### (1) First Embodiment

### (1.1) Overview

A background of accomplishment of a capacitor 1 of the present disclosure will be described.

Non-Patent Literature 1 discloses a layered structure including two electrodes and a multilayer film between the two electrodes, wherein the multilayer film includes insulator layers made of HfO₂ and semiconductor layers made of ZnO which are alternately stacked. The capacitance of the layered structure is increased by increasing the total number of the insulator layers and the semiconductor layers stacked to form the multilayer film. However, the layered structure has the problem that the capacitance easily changes along with a frequency change.

Thus, to suppress the capacitance from changing along with the frequency change, the inventors intensively conducted study on a layered structure including a multilayer film including insulator layers and a semiconductor layer(s) which are stacked one on top of another. As a result, the inventors have accomplished the invention of the present disclosure.

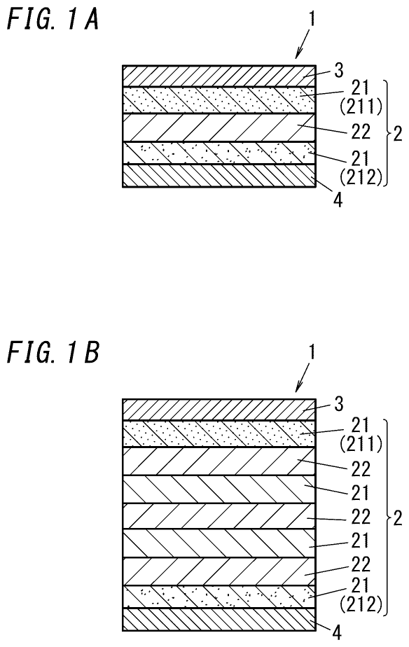

Embodiments and a variation will be described with reference to FIGS. 1A to 11. Note that the embodiments and variation described below are mere examples of various embodiments of the present disclosure. Further, various modifications may be made to the embodiments and variation described below depending on design or the like, as long as the object of the present disclosure is achieved. Furthermore, the configurations of the variation may accordingly be combined with each other.

Figures to be described below are schematic views, and the dimensions of components illustrated in these figures are not always to scale.

First of all, the overview of the capacitor 1 will be described with reference to FIGS. 1A and 1B. As shown in FIG. TA, the capacitor 1 includes an anode 3 and a cathode 4 as electrodes and a multilayer film 2 between the anode 3 and the cathode 4. That is, the capacitor 1 includes the anode 3, the multilayer film 2, and the cathode 4 stacked in this order.

As shown in FIGS. 1A and 1B, the multilayer film 2 includes at least two insulator layers 21 and at least one semiconductor layer 22, and the insulator layers 21 and the semiconductor layer 22 are alternately stacked. In other words, the semiconductor layer 22 is located between the two insulator layers 21, 21 in the multilayer film 2, and outermost layers of the multilayer film 2 are the insulator layers 21. Each of the anode 3 and the cathode 4 is in contact with a corresponding one of the insulator layers 21. In the present disclosure, the insulator layer 21 in contact with the anode 3 is referred to as a first insulator layer 211, and the insulator layer 21 in contact with the cathode 4 is referred to as a second insulator layer 212. That is, the insulator layers 21 include the first insulator layer 211 in contact with the anode 3 and the second insulator layer 212 in contact with the cathode 4. The capacitor 1 includes the multilayer film 2 as described above and can thus reliably have high capacitance.

As concerns the first insulator layer 211 and the second insulator layer 212 which are outermost layers of the multilayer film 2, the second insulator layer 212 has a thickness less than a thickness of the first insulator layer 211. This can suppress the capacitance from changing along with the frequency change. In particular, the capacitance of the capacitor 1 in application of an AC voltage is unlikely change along the frequency change. Therefore, when the capacitor 1 is connected to a direct-current power supply and is installed in a circuit, an alternating current component (voltage noise) generated from the direct-current power supply is removed, and thereby, a voltage supplied from the power supply can be stabilized. In other words, the capacitor 1 is preferably used as a bypass capacitor to be installed in a circuit to reduce the voltage noise. Note that the application of the capacitor 1 is not limited to the bypass capacitor. The capacitor 1 is applicable to various applications.

### (1.2) Details

Details of the capacitor 1 will be described.

### (Anode Cathode)

The capacitor 1 includes the anode 3 and the cathode 4 as the electrodes as described above. That is, when the capacitor 1 is installed in a circuit, the anode 3 of the capacitor 1 is electrically connected to a positive electrode of a power supply, and the cathode 4 is electrically connected to a negative electrode of the power supply or ground (e.g., earth). In the present embodiment, the two electrodes included in the capacitor 1 are distinguished from each other so that it is possible to determine which of them is the anode 3 and which is the cathode 4. A method of distinguishing between the anode 3 and the cathode 4 is not limited to a particular method. The anode 3 and the cathode 4 are distinguished from each other by, for example, providing the capacitor 1 with marks showing the distinctions between the anode 3 and the cathode 4, making the shape of the anode 3 and the shape of the cathode 4 different from each other, or defining the positional relationship between the anode 3 and the cathode 4 in the capacitor 1.

As described above, the insulator layers 21 include the first insulator layer 211 in contact with the anode 3 and the second insulator layer 212 in contact with the cathode 4. The thickness of the second insulator layer 212 is less than the thickness of the first insulator layer 211. In other words, an electrode in contact with the insulator layer 21 which is a thinner one of the two outermost insulator layers 21, 21 of the multilayer film 2 can be used as the cathode 4, and an electrode in contact with the insulator layer 21 which is thicker than and is located opposite the thinner insulator layer 21 can be used as the anode 3.

At least one of the anode 3 or the cathode 4 contains at least one selected from the group consisting of, for example, titanium (Ti), platinum (Pt), aluminum (Al), nickel (Ni), titanium nitride (TiN), tantalum (Ta), tantalum nitride (TaN), and gold (Au). At least one of the anode 3 or the cathode 4 preferably contains at least one of Ti, Pt, or Al. In this case, the capacitor 1 can have increased capacitance.

In the capacitor 1, the thickness of the anode 3 is, for example, greater than or equal to 0.01 μm and less than or equal to 1 mm, and the thickness of the cathode 4 is, for example, greater than or equal to 0.01 μm and less than or equal to 1 mm.

Each of the anode 3 and the cathode 4 can be formed by, for example, electron beam evaporation. In this case, the thickness of each of the anode 3 and the cathode 4 is readily adjusted. Moreover, each of the anode 3 and the cathode 4 may be, for example, a metal foil. Further, the metal foil may have a roughened surface. Thus, the metal foil can have an increased surface area, and the multilayer film 2 can also have an increased area in contact with the metal foil. A method of roughening the surface is not limited to a particular method, and, for example, etching may be employed. Furthermore, each of the anode 3 and the cathode 4 may be a porous body. In other words, metal included in each of the anode 3 and the cathode 4 may be, for example, porous metal. In this case, the capacitor 1 can have increased capacitance.

The cathode 4 may include, for example, a conductive polymer. Moreover, the conductive polymer includes at least one component selected from the group consisting of, for example, polypyrrole, polythiophene, polyaniline, and derivatives thereof.

### (Multilayer Film)

The capacitor 1 includes the multilayer film 2 as described above. The multilayer film 2 includes the at least two insulator layers 21 and the at least one semiconductor layer 22, and the insulator layers 21 and the semiconductor layer 22 are alternately stacked. Moreover, two outermost layers of the multilayer film 2 are the insulator layers 21, 21 as described above. That is, one semiconductor layer 22 is disposed on one insulator layer 21, and on the one semiconductor layer 22 is disposed one insulator layer 21, or on the one semiconductor layer 22 are a semiconductor layer(s) 22 and an insulator layer(s) 21 further alternately disposed and an insulator layer 21 is finally disposed as an outermost layer. Thus, the number of semiconductor layers 22 is one less than the number of insulator layers 21 in the multilayer film 2.

The total number of insulator layers 21 and semiconductor layer(s) 22 stacked to form the multilayer film 2 is preferably larger than or equal to three and smaller than or equal to nine. In this case, the capacitance can be further suppressed from changing along with the frequency change. Moreover, the total number of insulator layers 21 and semiconductor layer 22 stacked to form the multilayer film 2 is particularly preferably three. In other words, the insulator layers 21 particularly preferably consist of the first insulator layers 211 and the second insulator layers 212. In this case, the capacitor 1 in which the capacitance can be further suppressed from changing along with the frequency change can be efficiently produced. Note that when the total number of insulator layers 21 and semiconductor layer 22 stacked to form the multilayer film 2 is three, the number of the insulator layers 21 is two, and the number of the semiconductor layer 22 is one.

### <Insulator Layer>

The multilayer film 2 includes the insulator layers 21 as described above.

The insulator layers 21 contains a compound of at least one metal selected from the group consisting of, for example, aluminum (Al), silicon (Si), tantalum (Ta), and hafnium (Hf). More specifically, the insulator layers 21 contain at least one selected from the group consisting of, for example, Al₂O₃, SiO₂, Ta₂O₅, and HfO₂ which are oxides of the metals described above. In this case, the capacitor 1 can have increased capacitance. Moreover, at least one of the insulator layers 21 particularly preferably contains Al₂O₃. In this case, the capacitor 1 can have particularly increased capacitance. Note that one insulator layer 21 may contain only one type of metal compound or two or more types of metal compounds.

Moreover, a surface of metal which can be the anode 3 may be oxidized by anodization, thereby producing metal provided with an oxide coating, and an oxide coating portion of the metal may be used as the first insulator layer 211. Moreover, a portion which is unoxidized at this time may be used as the anode 3. Note that the metal provided with the oxide coating obtained by the anodization may be used as the cathode 4. In this case, the oxide coating portion of the metal provided with the oxide coating may be used as the second insulator layer 212, and the unoxidized portion may be used as the cathode 4.

As concerns the difference between the thickness of the first insulator layer 211 and the thickness of the second insulator layer 212, the thickness of the second insulator layer 212 is preferably lower than or equal to 90% of the thickness of the first insulator layer 211. In this case, while the capacitance of the capacitor 1 is suppressed from changing along the frequency change, an increase in the capacitance of the capacitor 1 can be achieved. More specifically, the capacitance of the capacitor 1 at 1 MHz tends to increase as the thickness of the second insulator layer 212 decreases, and thus, in order to achieve a 5% or higher increase in the capacitance of the capacitor 1 at 1 MHz, the thickness of the second insulator layer 212 is preferably lower than or equal to 90% of the thickness of the first insulator layer 211. In this case, while the capacitance of the capacitor 1 is suppressed from changing along the frequency change, an increase in the capacitance of the capacitor 1 can be achieved.

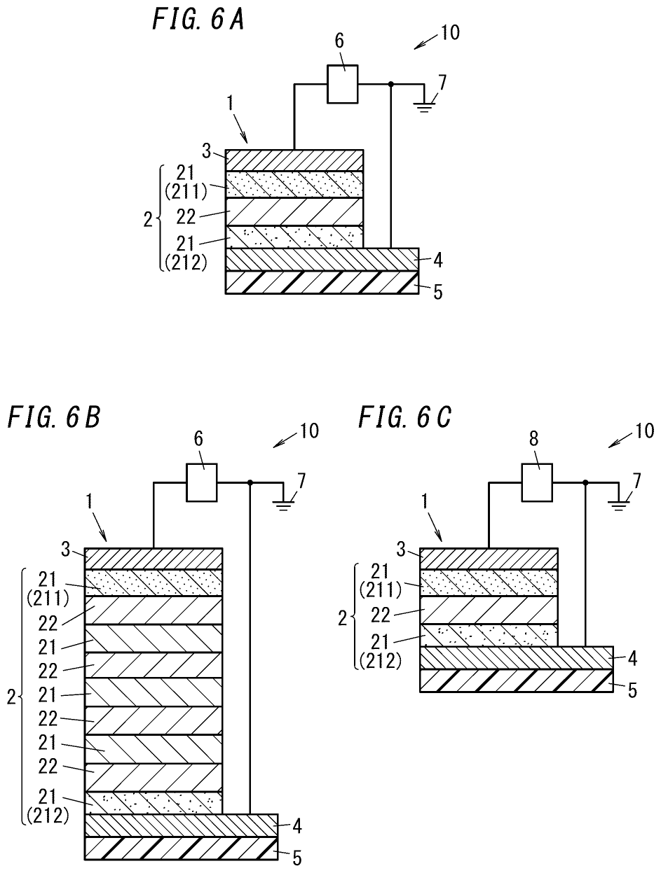

The thickness of the second insulator layer 212 is preferably, for example, greater than or equal to 2.5 nm and less than or equal to 18.0 nm. In this case, the withstand voltage characteristics of the capacitor 1 are suppressed from deteriorating, and the capacitance of the capacitor 1 can be suppressed from changing along with the frequency change. As described above, when the thickness of the second insulator layer 212 is greater than or equal to 2.5 nm, the withstand voltage characteristics of the capacitor 1 can be suppressed from deteriorating. In other words, the current-voltage characteristics of the capacitor 1 can be satisfactorily maintained. Thus, the capacitor 1 is readily applied to, for example, the bypass capacitor. Moreover, the current-voltage characteristics of the capacitor 1 can be confirmed by using a semiconductor parameter analyzer 8 (product name: Semiconductor parameter analyzer 4155C, distributor: Keysight Technologies). More specifically, the current-voltage characteristics of the capacitor 1 can be confirmed with reference to voltage and current density relationships obtained by producing an evaluation circuit 10 (see FIG. 6C) including the capacitor 1 and the semiconductor parameter analyzer 8 and applying, between the anode 3 and the cathode 4 of the capacitor 1, a sweep voltage from 0 V to a voltage (electric breakdown voltage) at which an electric breakdown occurs with a sweep voltage step width of 50 mV.

In the present disclosure, the current-voltage characteristics of the capacitor 1 can be confirmed with reference to voltage and current density relationships obtained by applying a voltage between the anode 3 and the cathode 4 such that the potential of the anode 3 is higher than the potential of the cathode 4 (forward bias), and the current-voltage characteristics of the capacitor 1 can be confirmed with reference to voltage and current density relationships obtained by applying a voltage between the anode 3 and the cathode 4 such that the potential at the anode 3 is lower than the potential of the cathode 4 (reverse bias).

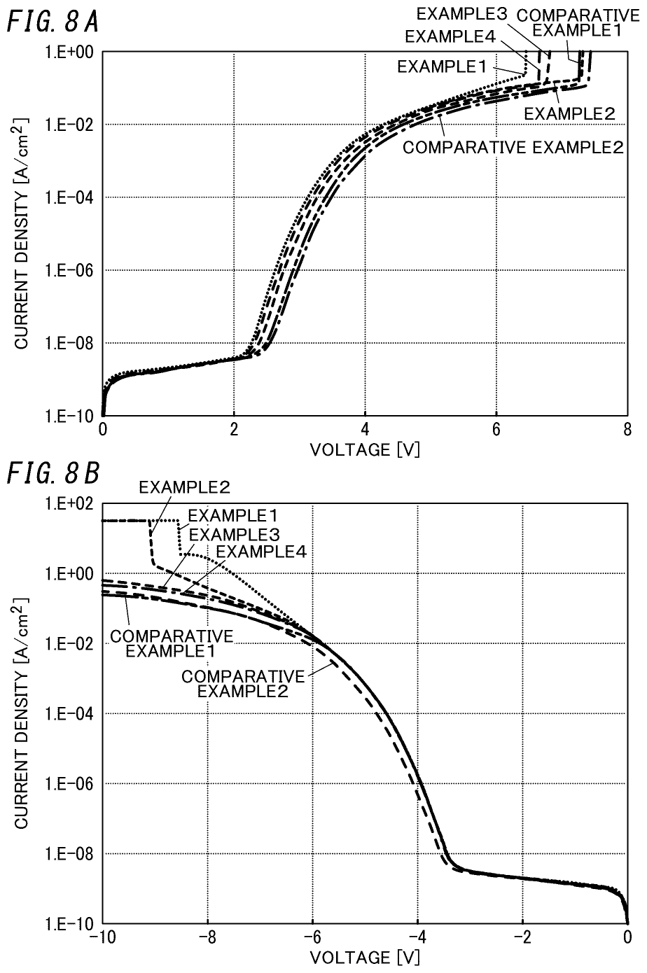

Moreover, saying that “the current-voltage characteristics are maintained” represents, as concerns the capacitor 1, that when the absolute value of the voltage applied to the anode 3 is gradually increased, a gradual increase in current density with an increasing difference between the potential of the anode 3 and the potential of the cathode 4 is maintained, and the current density does not rapidly change (see Examples 2 to 4 in FIG. 8B).

The thickness of each insulator layer 21 can be measured by using a transmission electron microscope (TEM). More specifically, the thickness of each insulator layer 21 can be an average value of values of thicknesses measured at five or more arbitrarily selected points by using the TEM.

### <Semiconductor Layer>

The multilayer film 2 includes the semiconductor layer 22 as described above. As described above, the outermost layers of the multilayer film 2 are the insulator layers 21. Thus, the semiconductor layer 22 is in contact with neither the anode 3 nor the cathode 4. In still other words, the semiconductor layer 22 is short-circuited with neither the anode 3 nor the cathode 4, and when there are a plurality of semiconductor layers 22, none of the plurality of semiconductor layers 22 is short-circuited with the anode 3 or the cathode 4.

The semiconductor layer 22 contains a compound of at least one metal selected from the group consisting of, for example, zinc (Zn) and titanium (Ti). More specifically, the semiconductor layer 22 contains at least one selected from the group consisting of ZnO and TiO₂ which are oxides of the metals described above. In this case, the capacitor 1 can have increased capacitance. The semiconductor layer 22 particularly preferably contains ZnO. Moreover, when the multilayer film 2 includes a plurality of, that is, two or more, semiconductor layers 22, at least one of the plurality of semiconductor layers 22 is particularly preferably contains ZnO. In this case, the capacitor 1 can have particularly increased capacitance.

The thickness of the semiconductor layer 22 is preferably greater than or equal to 2.5 nm and less than or equal to 15.0 nm. In this case, as concerns the capacitor 1, the capacitance can particularly be suppressed from changing along with the frequency change. The thickness of the semiconductor layer 22 is more preferably greater than or equal to 5.0 nm. The thickness of the semiconductor layer 22 is more preferably less than or equal to 10.0 nm. Moreover, the thickness of the semiconductor layer 22 can be measured by the same method as that used in the case of the insulator layers 21.

### (1.3) Production Method

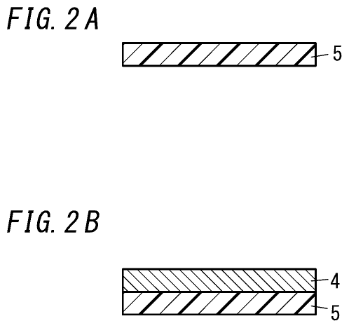

A production method of the capacitor 1 will be described with reference to FIGS. 2A to 2B, FIGS. 3A to 3D, FIG. 4, and FIG. 5. Note that the production method of the capacitor 1 described below is an example of a method of producing the capacitor 1. That is, as the production method of the capacitor 1, an appropriate production method may be employed depending on the application and purpose of use of the capacitor 1.

The production method of the capacitor 1 includes sequentially forming the cathode 4, the multilayer film 2, and the anode 3 on a substrate 5 (see from FIGS. 2A to 5). In other words, the production method of the capacitor 1 includes a cathode forming step, a multilayer film forming step, an anode forming step, and an etching step. These steps will be described in detail below.

### <Cathode Forming Step>

The cathode forming step includes, first of all, preparing the substrate 5 as shown in FIG. 2A. As the substrate 5, for example, a Si substrate is used. Subsequently, the substrate 5 is washed with, for example, etchant, thereby removing contaminants such as organic substances adhering to a surface of the substrate 5. Preferred examples of the etchant include buffered hydrofluoric acid (a liquid of a mixture of hydrofluoric acid and ammonium fluoride).

Then, on the substrate 5 thus washed is formed the cathode 4 as shown in FIG. 2B. Examples of a method of forming the cathode 4 include electron beam evaporation by which continuous film formation is performed to form the cathode 4 containing appropriate metal. Note that the electron beam evaporation is a method of irradiating an evaporation material with an electron beam in a vacuum to heat and evaporate the evaporation material, thereby depositing the evaporation material on the substrate 5 to form a thin film. Examples of the evaporation material used to form the cathode 4 in the present disclosure include Ti, Pt, Al, Ni, TiN, Ta, TaN, and Au.

### <Multilayer Film Forming Step>

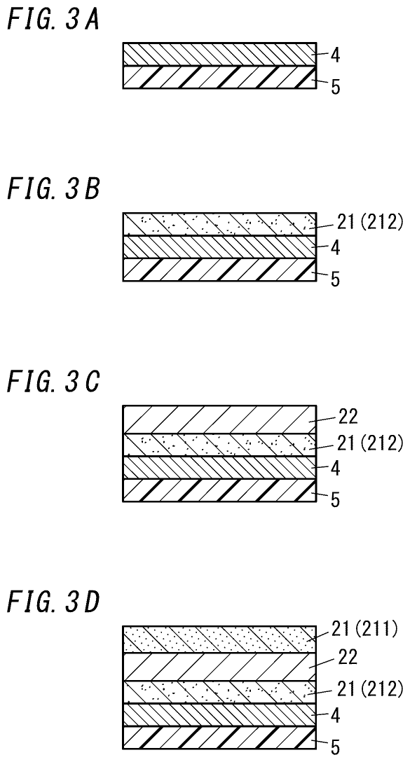

First of all, the second insulator layer 212 is formed on the cathode 4 (see FIGS. 3A and 3B). Subsequently, the semiconductor layer 22 is formed on the second insulator layer 212 formed on the cathode 4 (see FIG. 3C). Then, the first insulator layer 211 is formed on the semiconductor layer 22 (see FIG. 3D). The multilayer film 2 is formed by such a procedure. Note that a procedure which further includes, as necessary, alternately forming one or more insulator layers 21 and one or more semiconductor layers 22 on the semiconductor layer 22, which has been formed on the second insulator layer 212, followed by finally forming the first insulator layer 211 enables a multilayer film 2 in which the total number of insulator layers 21 and semiconductor layers 22 stacked one on top of another is larger than or equal to three to be formed.

Examples of the method of forming the insulator layers 21 and the semiconductor layer(s) 22 include atomic layer deposition (ALD). The atomic layer deposition is a film formation method including alternately supplying, by using an atomic layer deposition device (ALD device), an oxidizing agent and a source gas including metal to a reaction chamber in which an object is disposed, and thereby, a layer containing metal oxide is formed on a surface of the object. Since the atomic layer deposition causes reactions in a self-limiting manner, metal is deposited on the surface of the object in units of atomic layer. One cycle of the film formation method is made up of adsorption of a metal raw material by supply of a source gas, removal of an excess raw material by exhaustion (a purge) of the source gas, oxidation of the metal raw material by supply of an oxidizing agent, and exhaustion (a purge) of the oxidizing agent, and adjusting the number of the cycles can control the thickness of a layer to be formed. As the source gas, a gasified organic metal compound is preferably used. Moreover, a depressurized atmosphere is preferably achieved in the reaction chamber before the film formation, and the multilayer film 2 is preferably formed in the depressurized atmosphere in the reaction chamber, wherein the pressure in the reaction chamber is specifically reduced to, for example, 26.7 Pa or lower.

The film formation is performed while an inert gas is caused to flow at a fixed flow rate in the reaction chamber. As the inert gas, for example, N₂ or Ar is used. The flow rate of the inert gas is, for example, 4.39×10⁻¹ Pa·m³/s.

The amount of time for supplying the source gas to adsorb the metal raw material is, for example, longer than or equal to 0.12 seconds and shorter than or equal to 0.14 seconds. The exhaustion (purge) of the excess source gas is performed by causing the inert gas to flow. As the inert gas, N₂ or Ar is used. Note that the flow rate of the inert gas when the excess source gas is exhausted (purged) is, for example, 4.39×10⁻¹ Pa·m³/s as described above. The amount of time for exhausting (purging) the excess source gas is, for example, longer than or equal to 10 seconds and shorter than or equal to 20 seconds.

The amount of time for supplying the oxidizing agent to oxidize the metal raw material thus adsorbed is, for example, longer than or equal to 0.06 seconds and shorter than or equal to 0.07 seconds. Note that as the oxidizing agent, for example, H₂O, O₂ plasma, or O₃ may be used, and among them, H₂O is preferably used. The exhaustion (purge) of the excess oxidizing agent is performed by causing the inert gas to flow. As the inert gas, N₂ or Ar is used. Note that the flow rate of the inert gas when the excess oxidizing agent is exhausted (purged) can be the same as the flow rate of the inert gas when the excess source gas is exhausted (purged). The amount of time for exhausting (purging) the excess oxidizing agent is, for example, longer than or equal to 10 seconds and shorter than or equal to 20 seconds.

Moreover, for forming a layer by the atomic layer deposition, a temperature in forming the layer may be, for example, 150° C. Thus, a chemical reaction which occurs when the insulator layers 21 and the semiconductor layer(s) 22 are formed is readily adjusted, and thereby, the insulator layers 21 and the semiconductor layer(s) 22 can be stably formed.

The source gas used to form the insulator layers 21 contains a compound of at least one metal selected from the group consisting of, for example, Al, Si, Ta, and Hf. In still other words, the source gas used to form the insulator layers 21 contains at least one selected from the group consisting of, for example, organic metal compounds including Al, organic metal compounds including Si, organic metal compounds including Ta, and organic metal compounds including Hf.

Examples of the organic metal compounds containing Al include trimethylaluminum (TMA, (CH₃)₃Al). When an organic metal compound containing Al is used, insulator layers 21 containing Al₂O₃ having an adjusted thickness can be formed.

Examples of the organic metal compounds containing Si include tris(dimethylamino)silane (3DMAS, HSi[N(CH₃)₂]₃). When an organic metal compound containing Si is used, insulator layers 21 containing SiO₂ having an adjusted thickness can be formed.

Examples of the organic metal compounds containing Ta include (t-butylimide) tris(ethylmethylamino)tantalum (V) (TBTEMT, (CH₃)₃CNTa[N(C₂H₅)CH₃]₃). When an organic metal compound containing Ta is used, insulator layers 21 containing Ta₂O₅ having an adjusted thickness can be formed.

Examples of the organic metal compounds containing Hf include tetrakis(ethylmethylamino)hafnium (TEMAH, Hf[N(C₂H₅)CH₃]₄). When an organic metal compound containing Hf is used, insulator layers 21 containing HfO₂ having an adjusted thickness can be formed.

The source gas used to form the semiconductor layer(s) 22 includes a compound of at least one metal selected from the group consisting of, for example, Zn and Ti. In still other words, the source gas used to form the semiconductor layer(s) 22 includes at least one selected from the group consisting of, for example, organic metal compounds including Zn and organic metal compounds including Ti.

Examples of the organic metal compounds containing Zn include diethyl zinc (DEZ, Zn(C₂H₅)₂). When an organic metal compound including Zn is used, a semiconductor layer(s) 22 containing ZnO having an adjusted thickness can be formed.

Examples of the organic metal compounds containing Ti include tetrakis(dimethylamide)titanium (TDMAT, Ti[N(CH₃)₂]₄). When an organic metal compound containing Ti is used, a semiconductor layer(s) 22 containing TiO₂ having an adjusted thickness can be formed.

### <Anode Forming Step>

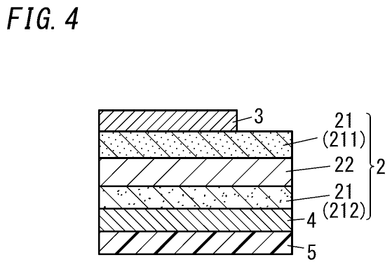

The anode 3 is formed on the outermost insulator layer 21, that is, the first insulator layer 211, of the multilayer film 2 (see FIG. 4). To form the anode 3, a method similar to the method of forming the cathode 4 is applicable, and for example, an anode 3 including an appropriate metal may be formed by the electron beam evaporation. Moreover, the same material as the evaporation material used to form the cathode 4 may be used to form the anode 3.

The anode 3 is formed to partially cover, for example, a surface of the first insulator layer 211 facing the anode 3 (see FIG. 4). Thus, a portion of the multilayer film 2 which is not sandwiched between the anode 3 and the cathode 4 can be easily removed in the etching step described later.

### <Etching Step>

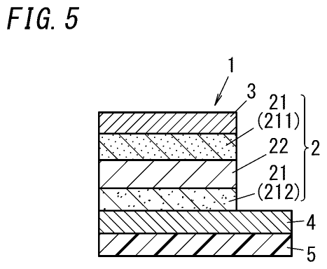

The portion of the multilayer film 2 which is not sandwiched between the anode 3 and the cathode 4 is removed by etching (see FIG. 5). This can partially expose the cathode 4, so that an exposed portion of the cathode 4 can be electrically connected to the negative electrode of the power supply or ground. Note that in the above description, the anode 3 is used as a mask for the etching, but to protect the anode 3 and/or the interface between the anode 3 and the first insulator layer 211 from damage during the etching, the anode 3 and the peripheral part thereof may be protected by, for example, a resist, and then, the etching may be performed.

The capacitor 1 is thus produced by the procedure described above. Note that the method of producing the capacitor 1 is not limited to the procedure of sequentially forming the cathode 4, the multilayer film 2, and the anode 3 on the substrate 5 as described above, but a method of sequentially forming the anode 3, the multilayer film 2, and the cathode 4 on the substrate 5 may be employed to produce the capacitor 1.

### (1.4) Performance

The performance of the capacitor 1 will be described.

The capacitor 1 includes the multilayer film 2 including the insulator layers 21 and the semiconductor layer 22, which are alternately stacked, as described above. This can implement higher capacitance of the capacitor 1 than a theoretical value C of series capacitance expressed by Formula (1) below.

$$1 / C = {\sum }_{k = 1}^{n} ( 1 / ( \frac{{ε}_{k} {ε}_{0} S}{{d}_{k}} ) ) \qquad ( 1 )$$

C is the theoretical value of the series capacitance,
εₖ is relative permittivity of a k-th insulator layer when the first insulator layer is the first one in a direction from the anode toward the cathode,
ε₀ is permittivity of a vacuum,
S is a facing area of the anode and the cathode,
n is the total number of the insulator layers, and
dₖ is a thickness of the k-th insulator layer when the first insulator layer is the first one in the direction from the anode toward the cathode.

In Formula (1), εₖ is the relative permittivity of the k-th insulator layer 21 when the first insulator layer 211 is the first one in the direction from the anode 3 toward the cathode 4. Moreover, ε₀ is the permittivity (8.85×10⁻¹² F/m) of the vacuum.

In Formula (1), S is the facing area of the anode 3 and the cathode 4. The facing area of the anode 3 and the cathode 4 is the area of a portion, corresponding to the cathode 4, of a surface which the anode 3 has and which is on the side of the cathode 4 and is the area of a portion, corresponding to the anode 3, of a surface which the cathode 4 has and which is on the side of the anode 3.

In Formula (1), n is the total number of the insulator layers 21. As concerns the multilayer film 2, the insulator layers 21 include at least two insulator layers 21 as described above. Moreover, the total number of the semiconductor layers 22 of the multilayer film 2 is one less than the total number of the insulator layers 21 as described above. Therefore, in Formula (1), when the total number of the insulator layers 21 is denoted by n, the total number of the semiconductor layers 22 is denoted by (n−1).

In Formula (1), dₖ is the thickness of the k-th insulator layer 21 when the first insulator layer 211 is the first one in the direction from the anode 3 toward the cathode 4.

Moreover, as the measurement frequency decreases, the capacitance of the capacitor 1 tends to increase. Specifically, the capacitor 1 tends to have increased capacitance when the measurement frequency is less than or equal to 1 Mz, and the capacitor 1 tends to have further increased capacitance when the measurement frequency is less than or equal to 1,000 Hz. Further, when the measurement frequency is 100 Hz, the capacitor 1 tends to have particularly increased capacitance, and higher capacitance than the theoretical value C of the series capacitance expressed by Formula (1) can particularly be implemented.

Furthermore, as concerns the capacitor 1 of the present disclosure, the effect that the capacitance is suppressed from changing along with the frequency change is significantly observed in a specific measurement frequency range. More specifically, as concerns the capacitor 1, the thickness of the second insulator layer 212 is less than the thickness of the first insulator layer 211, and therefore, the effect that the capacitance is suppressed from changing along with the frequency change is suppressed is significant within the range of a measurement frequency higher than or equal to 100 Hz and lower than or equal to 1 MHz as compared with a capacitor in which the thickness of the first insulator layer 211 is equal to the thickness of the second insulator layer 212 or a capacitor in which the thickness of the second insulator layer 212 is greater than the thickness of the first insulator layer 211. As a result, the capacitor 1 can have enhanced performance of removing the voltage noise generated within the range of a measurement frequency greater than or equal to 100 Hz and less than or equal to 1 MHz. Moreover, as concerns the capacitor 1, the effect that the capacitance is suppressed from changing is more significant within the range of a measurement frequency higher than or equal to 1,000 Hz and lower than or equal to 1 MHz, the effect that the capacitance is suppressed from changing is much more significant within the range of a measurement frequency higher than or equal to 10,000 Hz and lower than or equal to 1 MHz, and the effect that the capacitance is suppressed from changing is particularly significant at a measurement frequency of 1 MHz.

As described above, as concerns the capacitor 1, the capacitance is particularly significantly suppressed from changing along with the frequency change at a measurement frequency of 1 MHz, and therefore, the difference between the capacitance of the capacitor 1 at the measurement frequency of 1 MHz and the capacitance of the capacitor 1 at the measurement frequency of 100 Hz can be small. Specifically, as concerns the capacitor 1, the capacitance between the anode 3 and the cathode 4 at a measurement frequency of 100 Hz can be 1.6 or less times, can also be 1.3 or less times, and can further be 1.2 or less times, the capacitance between the anode 3 and the cathode 4 at a measurement frequency of 1 MHz.

Note that as concerns the capacitor 1, the capacitances between the anode 3 and the cathode 4 in a measurement frequency range from 100 Hz to 1 MHz are measured values obtained by using an impedance analyzer 6 (product name: Impedance analyzer 4294A, distributor: Keysight Technologies). More specifically, the capacitances can be confirmed from measured values obtained when an evaluation circuit 10 (see FIGS. 6A and 6B) including the capacitor 1 and the impedance analyzer 6 are produced, and an AC voltage of 500 mV is applied between the anode 3 and the cathode 4, and the measurement frequency range is set to a range from 100 Hz to 1 MHz. Moreover, the evaluation circuit 10 is produced such that the impedance analyzer 6 is connected to the anode 3 and the cathode 4 of the capacitor 1 and the cathode 4 is further connected to ground 7.

### (2) Variation

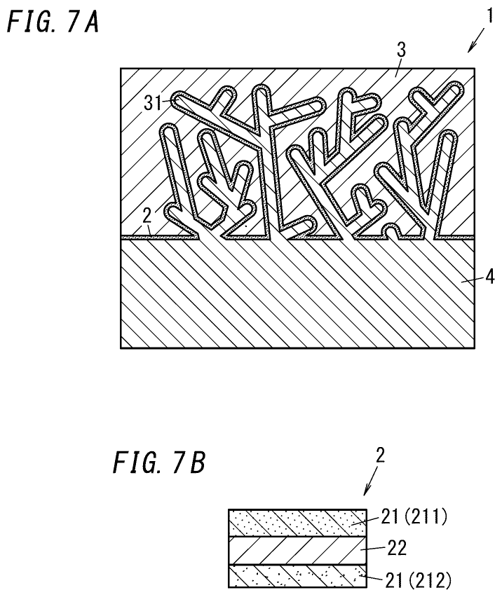

A variation of the capacitor 1 will be described with reference to FIGS. 7A and 7B. Note that the variation is an example of variations of the configuration of the embodiment, for example, in which some components are changed, to which some components are added, or from which some components are removed. Moreover, in the variation, components similar to those in the capacitor 1 of the embodiment are denoted by the same reference signs as those in the embodiment, and the description thereof is omitted.

In the variation, an anode 3 is a porous body having micro pores 31, and part of a cathode 4 is in the micro pores 31 of the anode 3 (see FIG. 7A). A multilayer film 2 (see FIG. 7B) is disposed between the part of the cathode 4 which is in the micro pores 31 and inner surfaces of the micro pores 31. Since the cathode 4 has the part in the micro pores 31, the facing area of the anode 3 and the cathode 4 can be large. As a result, a capacitor 1 can have increased capacitance. Note that a structure may be employed in which the cathode 4 is a porous body having the micro pores 31 and part of the anode 3 is in the cathode 4.

Moreover, since the capacitance of the capacitor 1 can be increased irrespective of a material for electrode. Thus, the anode 3 can contain aluminum (Al), and the cathode 4 can contain a conductive polymer. More specifically, the capacitor 1 includes the anode 3 containing Al, the multilayer film 2 including insulator layers 21 and a semiconductor layer 22 which are alternately stacked, and the cathode 4 containing the conductive polymer in this order, and a first insulator layer 211 in contact with the anode 3 can contain Al₂O₃. In this case, Al of the porous body is applied to the anode 3, and therefore, the capacitor 1 has high capacitance, while the conductive polymer is applicable to the cathode 4. Thus, the capacitor 1 is applicable to a conductive polymer aluminum electrolytic capacitor. At this time, the semiconductor layer 22 included in the multilayer film 2 contains, for example, ZnO. Moreover, the multilayer film 2 can be a dielectric coating located between the anode 3 and the cathode 4 and covering the cathode 4. Also when the anode 3 containing Al is the porous body as in this case, the atomic layer deposition can form the multilayer film 2 having a three-layer structure including a first insulator layer 211 containing Al₂O₃, the semiconductor layer 22 containing ZnO, and a second insulator layer 212 containing Al₂O₃. Moreover, also when the anode 3 has a surface provided with an anodization coating containing Al₂O₃, the multilayer film 2 can be formed by using the anodization coating as the first insulator layer 211, and forming two layers, namely, the semiconductor layer 22 containing ZnO and the second insulator layer 212 containing Al₂O₃, on the first insulator layer 211 by the atomic layer deposition.

Note that the cathode 4 may include both a conductive polymer and an electrode containing metal. Moreover, the cathode 4 does not have to include the conductive polymer. In other words, the capacitor 1 of the variation may have a configuration in which the cathode 4 includes no conductive polymer and a layer containing a conductive polymer is stacked between the second insulator layer 212 and the cathode 4 containing metal such as silver. Example

### 1. Evaluation (1) of Capacitor

### 1.1 Production Method of Evaluation Circuit

In accordance with the following procedure, capacitors 1 of Examples 1 to 4 and Comparative Examples 1 and 2 were produced, and respective evaluation circuits 10 including the capacitors 1 were produced (see FIGS. 6A and 6C).

### <Production of Capacitor>

Each capacitor 1 was produced by the following method.

First of all, a substrate 5 (material Si) was prepared, and the substrate 5 was washed with buffered hydrofluoric acid. On the substrate 5 thus washed was formed a cathode 4 (100 nm in thickness) containing Ti by the electron beam evaporation.

Then, while the substrate 5 with the cathode 4 formed thereon was immersed in an organic solvent such as acetone or isopropyl alcohol, the substrate 5 was washed by ultrasonic wave.

Subsequently, a second insulator layer 212 containing Al₂O₃ was formed on the cathode 4 by the atomic layer deposition by sequentially repeating a cycle made up of supplying trimethylaluminum gas, exhausting the trimethylaluminum gas, supplying H₂O gas, and exhausting the H₂O gas.

Then, a semiconductor layer 22 containing ZnO was formed on the second insulator layer 212 by a procedure similar to the procedure for forming the second insulator layer 212 except that the trimethylaluminum gas is replaced with diethyl zinc gas. Then, on the semiconductor layer 22 was formed a first insulator layer 211 containing Al₂O₃ in accordance with a procedure similar to the procedure for forming the second insulator layer 212.

Subsequently, on the first insulator layer 211 was formed an anode 3 (100 nm in thickness) containing Ti by electron beam evaporation.

Then, the multilayer film 2 on a portion, not corresponding to the anode 3, of a surface which the cathode 4 has and which is on the side of the anode 3 was removed by etching to expose part of the cathode 4, thereby producing the capacitor 1.

As concerns the capacitor 1 of each of Examples 1 to 4 and Comparative Examples 1 and 2, the thickness of the first insulator layer 211, the thickness of the second insulator layer 212, and the thickness of the semiconductor layer 22 were adjusted to have respective numerical values shown in Table 1. Note that as described above, insulator layers 21 (the first insulator layer 211 and the second insulator layer 212) and the semiconductor layer 22 were formed by the atomic layer deposition using an atomic layer deposition device (product name: Fiji F200, distributor: Cambridge Nanotech), and film formation conditions per cycle of the atomic layer deposition when the insulator layers 21 (the first insulator layer 211 and the second insulator layer 212) and the semiconductor layer 22 were formed were as follows.

### <Insulator Layer>

Film formation temperature: 150° C.
The amount of time for supplying source gas for adsorption of metal raw material: 0.12 seconds
The amount of time for exhaustion (purge) of excess source gas: 10 seconds
The amount of time for supplying an oxidizing agent for oxidizing the metal raw material: 0.06 seconds
The amount of time for exhaustion (purge) of the oxidizing agent to remove the oxidizing agent: 10 seconds

### <Semiconductor Layer>

Film formation temperature: 150° C.
The amount of time for supplying source gas for adsorbing metal raw material: 0.14 seconds
The amount of time for exhaustion (purge) of excess source gas: 20 seconds
The amount of time for supplying the oxidizing agent for oxidizing the metal raw material: 0.07 seconds
The amount of time for exhaustion (purge) of the oxidizing agent to remove the oxidizing agent: 20 seconds

Note that in the film formation, Ar was used as an inert gas, and the inert gas was caused to flow at a fixed flow rate. The flow rate of the inert gas was 4.39×10⁻¹ Pa·m³/s. That is, the exhaustion (purge) of the oxidizing agent for oxidizing the metal raw material and the oxidizing agent to remove the oxidizing agent was performed at the flow rate described above. Moreover, the number of cycles in the film formation in the atomic layer deposition was adjusted such that the thickness of the first insulator layer 211, the thickness of the second insulator layer 212, and the thickness of the semiconductor layer 22 have respective values shown in Table 1.

### <Production of Evaluation Circuit Used in Capacitance Measurement>

As concerns the capacitor 1 of each of Examples 1 to 4 and Comparative Examples 1 and 2, the anode 3 and part of the cathode 4 thus exposed were connected to an impedance analyzer 6, and the cathode 4 was further connected to the ground 7, thereby producing the evaluation circuit 10 (see FIG. 6A). Note that as the impedance analyzer 6, Impedance analyzer 4294A (manufactured by Keysight Technologies) was used.

### <Production of Evaluation Circuit Used in Current-Voltage Characteristics Measurement>

As concerns the capacitor 1 of each of Examples 1 to 4 and Comparative Examples 1 and 2, the anode 3 and part of the cathode 4 thus exposed were connected to a semiconductor parameter analyzer 8, and the cathode 4 was further connected to the ground 7, thereby producing an evaluation circuit 10 (see FIG. 6C). Note that as the semiconductor parameter analyzer 8, Semiconductor parameter analyzer 4155C (manufactured by Keysight Technologies) was used.

### 1.2 Evaluation Results

### <Capacitance>

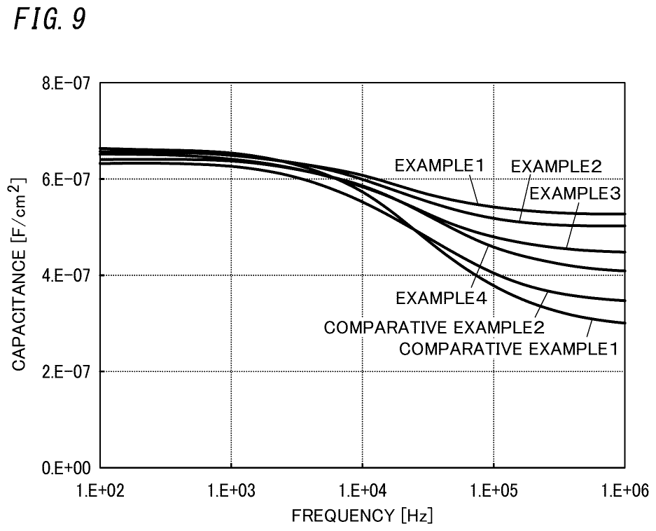

As concerns the evaluation circuit 10 including the capacitor 1 of each of Examples 1 to 4 and Comparative Examples 1 to 2, the capacitances of the capacitor 1 of each of Examples 1 to 4 and Comparative Examples 1 and 2 were measured by applying a voltage as an AC voltage of 500 mV between the anode 3 and the cathode 4 within the frequency range from 100 Hz to 1 MHz. As concerns the capacitor 1 of each of Examples 1 to 4 and Comparative Examples 1 and 2, the relationship between the measurement frequency and the capacitance is shown in FIG. 9. Measurement results of the capacitances obtained at measurement frequencies of 100 Hz and 1 MHz are shown in Table 1. Note that series capacitance theoretical values of the capacitors of Examples 1 to 4 and Comparative Examples 1 and 2 are values calculated in accordance with Formula (1) described in “(1.4) Performance”.

### <Current-Voltage Characteristics>

As concerns the evaluation circuit 10 including the capacitor 1 of each of Examples 1 to 4 and Comparative Examples 1 to 2, a sweep voltage from 0 V to a voltage (electric breakdown voltage) at which an electric breakdown occurs was applied to the anode 3 with a sweep voltage step width of 50 mV, and a current density corresponding to the voltage thus applied was measured, thereby confirming the voltage and current density relationships of the capacitors 1 of Examples 1 to 4 and Comparative Examples 1 and 2.

In a graph (see FIG. 8A) is summarized voltage and current density relationships obtained by applying a voltage between the anode 3 and the cathode 4 such that the potential of the anode 3 is higher than the potential of the cathode 4 (forward bias). Moreover, in a graph (see FIG. 8B) is summarized voltage and current density relationships obtained by applying a voltage between the anode 3 and the cathode 4 such that the potential of the anode 3 is lower than the potential of the cathode 4 (reverse bias). From the graphs of FIGS. 8A and 8B, “Withstand Voltage Characteristics Deterioration” is noted in the field of “Current-Voltage Characteristics” in Table 1 for the examples and comparative examples in which deterioration in the withstand voltage characteristics was confirmed.

TABLE 1

| | | | | | Evaluation Results | | | |
|---|---|---|---|---|---|---|---|---|
| | Multilayer Film | | | | Capacitance | | | |
| | | Thickness | | | | | Series | Current- |
| | The Number | First | Second | Semi- | | | Capacitance | Voltage |
| | of | Insulator | Insulator | conductor | Capacitance | Capacitance | Theoretical | Characteristics |
| | Stacked | Layer | Layer | Layer | @100 Hz | @1 MHz | Value | — |
| | Layers | nm | nm | nm | F/cm [symbol] | F/cm [symbol] | F/cm [symbol] | — |
| Example 1 | 3 | 8.3 | 1.8 | 5.1 | 6.6 × 10⁻⁷ | 5.3 × 10⁻ [symbol] | 6.2 × 10⁻ [symbol] | Withstand |
| | | | | | | | | Voltage |
| | | | | | | | | Characteristics |
| | | | | | | | | Deterioration |
| Example 2 | 3 | 8.3 | 2.5 | 5.1 | 6.6 × 10⁻ [symbol] | 5.0 × 10⁻⁷ | 5.8 × 10⁻⁷ | — |
| Example 3 | 3 | 8.3 | 3.9 | 5.1 | 6.5 × 10⁻⁷ | 4.5 × 10⁻⁷ | 5.5 × 10⁻⁷ | — |
| Example 4 | 3 | 8.3 | 6.1 | 5.1 | 6.7 × 10⁻⁷ | 4.1 × 10⁻ [symbol] | 5.1 × 10⁻⁷ | — |
| Comparative | 3 | 8.3 | 12.7 | 5.1 | 6.7 × 10⁻ [symbol] | 3.0 × 10⁻⁷ | 2.0 × 10⁻⁷ | — |
| Example 1 | | | | | | | | |
| Comparative | 3 | 8.3 | 8.3 | 5.1 | 6.4 × 10⁻ [symbol] | 3.5 × 1⁻ [symbol] | 3.7 × 10⁻⁷ | — |
| Example 2 | | | | | | | | |

[symbol]

indicates data missing or illegible when filed

It can be confirmed that the capacitor 1 of each of Examples 1 to 4 in which the thickness of the second insulator layer 212 is less than the thickness of the first insulator layer 211 has higher capacitance at 100 Hz than the series capacitance theoretical value, as well as in the capacitor 1 of Comparative Example 1 in which the thickness of the second insulator layer 212 is greater than the thickness of the first insulator layer 211 and the capacitor 1 of Comparative Example 2 in which the thickness of the first insulator layer 211 is equal to the thickness of the second insulator layer 212.

It is shown that the capacitors 1 of each of Examples 1 to 4 in which the thickness of the second insulator layer 212 is less than the thickness of the first insulator layer 211 has increased capacitance at a measurement frequency of 1 MHz as compared with the capacitor 1 of Comparative Example 1 in which the thickness of the second insulator layer 212 is greater than the thickness of the first insulator layer 211 and the capacitor 1 of Comparative Example 2 in which the thickness of the first insulator layer 211 is equal to the thickness of the second insulator layer 212, and that the smaller the thickness of the second insulator layer 212 is, the higher the capacitance.

It is shown that the capacitor of each of Examples 1 to 4 in which the thickness of the second insulator layer 212 is smaller than the thickness of the first insulator layer 211 has a small difference between the capacitance at the measurement frequency of 100 Hz and the capacitance at the measurement frequency of 1 MHz as compared with the capacitor 1 of Comparative Example 1 in which the thickness of the second insulator layer 212 is greater than the thickness of the first insulator layer 211 and the capacitor 1 of Comparative Example 2 in which the thickness of the first insulator layer 211 is equal to the thickness of the second insulator layer 212; and that the smaller the thickness of the second insulator layer 212 is, the smaller the difference.

As concerns the capacitor 1 of each of Examples 1 to 4, it is shown that the capacitance at the measurement frequency of 100 Hz is higher than the series capacitance theoretical value.

In the capacitor 1 of each of Examples 2 to 4, the second insulator layer 212 has an appropriate thickness. Therefore, it is shown that unlike in the capacitor 1 of Example 1, a rapid increase in current density (see Example 1 of FIG. 8B) is not observed in the capacitor 1 of each of Examples 2 to 4, and the current-voltage characteristics are readily maintained.

### 2. Evaluation (2) of Capacitor

### 2.1 Production Method of Evaluation Circuit

In accordance with the procedure described in “1. Evaluation 1 of Capacitor, 1.1 Production Method of Evaluation Circuit”, capacitors 1 of Example 5 and Comparative Example 3 each including an anode 3 (100 nm in thickness) containing Ti, a multilayer film 2, and a cathode 4 (100 nm in thickness) containing Ti were produced, and evaluation circuits 10 (see FIG. 6A) each including a corresponding one of the capacitors 1 and an impedance analyzer 6 were produced.

The multilayer film 2 has a three-layer structure including a first insulator layer 211 containing Al₂O₃, a semiconductor layer 22 containing ZnO, and a second insulator layer 212 containing Al₂O₃. Insulator layers 21 were formed by a procedure similar to the procedure for forming the insulator layers 21 described in “1. Evaluation 1 of Capacitor, 1.1. Production Method of Evaluation Circuit”. Moreover, the semiconductor layer 22 was also formed by a procedure similar to the procedure for forming the semiconductor layer 22 described in “1. Evaluation 1 of Capacitor, 1.1 Production Method of Evaluation Circuit”.

The thicknesses of the insulator layers 21 (the thickness of the first insulator layer 211 and the thickness of the second insulator layer 212) and the thickness of the semiconductor layer 22 were adjusted to respective numerical values shown in Table 2. Note that the number of cycles when the film formation was performed by the atomic layer deposition was adjusted such that the thickness of the first insulator layer 211, the thickness of the second insulator layer 212, and the thickness of the semiconductor layer 22 have respective values shown in Table 2.

### 2.2 Evaluation Results

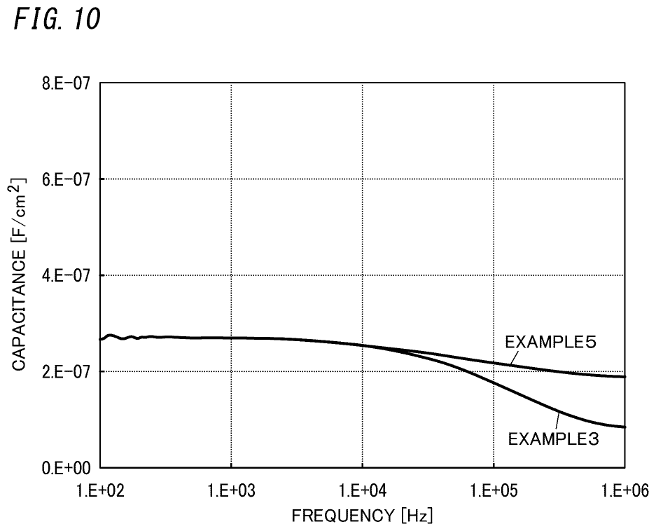

As concerns the evaluation circuit 10 including the capacitor 1 of each of Example 5 and Comparative Example 3, the capacitances of the capacitor 1 of each of Example 5 and Comparative Example 3 were evaluated by applying a voltage as an AC voltage of 500 mV between the anode 3 and the cathode 4 within the frequency range from 100 Hz to 1 MHz. As concerns the capacitor 1 of each of Example 5 and Comparative Example 3, the relationship between the measurement frequency and the capacitance is shown in FIG. 10. Measurement results of the capacitance obtained at measurement frequencies of 100 Hz and 1 MHz are shown in Table 2. Note that the series capacitance theoretical values of Example 5 and Comparative Example 3 are values calculated in accordance with Formula (1) described in “(1.4) Performance”.

TABLE 2

| | Multilayer Film | | | | Evaluation Results | | |
|---|---|---|---|---|---|---|---|
| | | Thickness | | | Capacitance | | |
| | | First Insulator | Second Insulator | Semiconductor | Capacitance | Capacitance | Series Capacitance |
| | The Number of | Layer | Layer | Layer | @100 Hz | @1 MHz | Theoretical Value |
| | Stacked Layers | nm | nm | nm | F/cm [symbol] | F/cm [symbol] | F/cm [symbol] |
| Example 5 | 3 | 20.5 | 10 | 5.1 | 2.8 × 10⁻⁷ | 1.9 × 10⁻⁷ | 2.0 × 10⁻⁷ |
| Comparative | 3 | 20.5 | 20.5 | 5.1 | 2.7 × 10⁻⁷ | 0.8 × 10⁻⁷ | 1.5 × 10⁻⁷ |
| Example 3 | | | | | | | |

[symbol]

indicates data missing or illegible when filed

It is shown that in the capacitor 1 of each of Example 5 and Comparative Example 3, the first insulator layer 211 has an increased thickness as compared with the capacitor 1 of Examples 1 to 4 and Comparative Example 1 and 2, but in the capacitor 1 of Example 5, the thickness of the second insulator layer 212 is less than the thickness of the first insulator layer 211 as compared with the capacitor 1 of Comparative Example 3, and thus, the capacitor 1 of Example 5 has increased capacitance at the measurement frequency of 1 MHz.

Further, it is shown that in the capacitor 1 of each of Example 5 and Comparative Example 3, the first insulator layer 211 has an increased thickness as compared with the capacitor 1 of Examples 1 to 4 and Comparative Example 1 and 2, but the capacitor 1 of Example 5 in which the thickness of the second insulator layer 212 is less than the thickness of the first insulator layer 211 has a small difference between the capacitance at the measurement frequency of 100 Hz and the capacitance at the measurement frequency of 1 MHz as compared with the capacitor 1 of Comparative Example 3 in which the thickness of the first insulator layer 211 is equal to the thickness of the second insulator layer 212.

### 3. Evaluation (3) of Capacitor

### 3.1 Production Method of Evaluation Circuit

In accordance with the procedure described in “1. Evaluation 1 of Capacitor, 1.1 Production Method of Evaluation Circuit”, capacitors 1 of Example 5 and Comparative Example 3 each including an anode 3 (100 nm in thickness) containing Ti, a multilayer film 2, and a cathode 4 (100 nm in thickness) containing Ti were produced, and evaluation circuits 10 (see FIG. 6B) each including a corresponding one of the capacitors 1 and an impedance analyzer 6 were produced.

The multilayer film 2 has a nine-layer structure including insulator layers 21 containing Al₂O₃ and semiconductor layers 22 containing ZnO which are alternately stacked. The insulator layers 21 were formed by a procedure similar to the procedure for forming the insulator layer 21 described in “1. Evaluation 1 of Capacitor, 1.1 Production Method of Evaluation Circuit”. Moreover, the semiconductor layers 22 were formed by a procedure similar to the procedure for forming the semiconductor layer 22 described in “1. Evaluation 1 of Capacitor, 1.1 Production Method of Evaluation Circuit”.

The thicknesses of the insulator layers 21 (the thickness of a second insulator layer 212 and the thickness of each of the insulator layers 21 except for the second insulator layer 212) and the thickness of each of the semiconductor layers 22 were adjusted to respective numerical values shown in Table 3. Note that in the capacitor 1 of each of Example 6 and Comparative Example 4, the insulator layers 21 except for the second insulator layer 212 have the same thickness, and the semiconductor layers 22 all have the same thickness. Moreover, the number of cycles in the film formation by the atomic layer deposition was adjusted such that the thickness of the second insulator layer 212, the thickness of each of the insulator layers 21 except for the second insulator layer 212, and the thickness of each of the semiconductor layers 22 have respective values shown in Table 3.

### 3.2 Evaluation Results

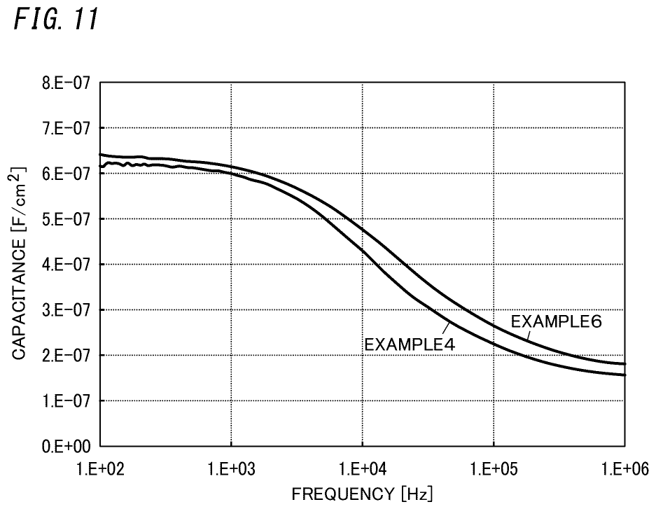

As concerns the evaluation circuit 10 including the capacitor 1 of each of Example 6 and Comparative Example 4, the capacitances of the capacitor 1 of each of Example 6 and Comparative Example 4 were evaluated by applying a voltage as an AC voltage of 500 mV between the anode 3 and the cathode 4 within the frequency range from 100 Hz to 1 MHz. As concerns the capacitor 1 of each of Example 6 and Comparative Example 4, the relationship between the measurement frequency and the capacitance is shown in FIG. 11. Measurement results of the capacitance obtained at measurement frequencies of 100 Hz and 1 MHz are shown in Table 3. Note that series capacitance theoretical values in Example 6 and Comparative Example 4 are values calculated in accordance with Formula (1) described in “(1.4) Performance”.

TABLE 3

| | Multlayer Film | | | | Evaluation Results | | |
|---|---|---|---|---|---|---|---|
| | | Thickness | | | Capacitance | | |
| | | First Insulator | Second Insulator | Semiconductor | Capacitance | Capacitance | Series Capacitance |
| | The Number of | Layer | Layer | Layer | @100 Hz | @1 MHz | Theoretical Value |
| | Stacked Layers | nm | nm | nm | F/cm [symbol] | F/cm [symbol] | F/cm [symbol] |
| Example 6 | 9 | 8.3 | 3.9 | 5.1 | 6.4 × 10⁻⁷ | 1.8 × 10⁻⁷ | 1.7 × 10⁻⁷ |
| Comparative | 9 | 8.3 | 8.3 | 5.1 | 6.3 × 10⁻⁷ | 1.6 × 10⁻⁷ | 1.5 × 10⁻⁷ |
| Example 4 | | | | | | | |

[symbol]

indicates data missing or illegible when filed

It is shown that since the capacitor 1 of Example 6 has an increased number of layers in the multilayer film as compared with the capacitor 1 of Example 3, an improvement in capacitance at 1 MHz is small even when the thickness of the second insulator layer 212 is reduced. This shows that reducing the number of layers in the multilayer film can enhance the effect of suppressing the frequency dependency.

### (3) Summary

As can be seen from the embodiment described above, a capacitor (1) of a first aspect of the present disclosure includes an anode (3), a multilayer film (2), and a cathode (4) stacked in this order. The multilayer film (2) includes at least two insulator layers (21) and at least one semiconductor layer (22), and the at least two insulator layers (21) and the at least one semiconductor layer (22) are alternately stacked. The at least two insulator layers (21) include a first insulator layer (211) in contact with the anode (3) and a second insulator layer (212) in contact with the cathode (4). The second insulator layer (212) has a thickness less than a thickness of the first insulator layer (211).

The first aspect can provide the capacitor (1) including the multilayer film (2) including the at least two insulator layers (21) and the at least one semiconductor layer (22) stacked one on top of another, wherein the capacitance of the capacitor (1) can be suppressed from changing along with a frequency change.

In a capacitor (1) of a second aspect of the present disclosure referring to the first aspect, at least one of the at least two insulator layers (21) contains Al₂O₃.

With the second aspect, the capacitor (1) can have particularly increased capacitance.

In a capacitor (1) of a third aspect of the present disclosure referring to the first or second aspect, the second insulator layer (212) has a thickness greater than or equal to 2.5 nm and less than or equal to 18.0 nm.

With the third aspect, the withstand voltage characteristics of the capacitor (1) is suppressed from deteriorating, and the capacitance of the capacitor (1) can be suppressed from changing along with a frequency change.

In a capacitor (1) of a fourth aspect of the present disclosure referring to any one of the first to third aspects, the at least two insulator layers (21) consist of the first insulator layer (211) and the second insulator layer (212).

With the fourth aspect, the capacitor (1) having capacitance which can be suppressed from changing along with a frequency change can be produced efficiently.

In a capacitor (1) of a fifth aspect of the present disclosure referring to any one of the first to fourth aspects, capacitance between the anode (3) and the cathode (4) at a measurement frequency of 100 Hz is higher than a theoretical value of series capacitance of the at least two insulator layers (21) represented by Formula (1) below.

$$1 / C = {\sum }_{k = 1}^{n} ( 1 / ( \frac{{ε}_{k} {ε}_{0} S}{{d}_{k}} ) ) \qquad ( 1 )$$

C is the theoretical value of the series capacitance,
εₖ is relative permittivity of a k-th insulator layer when the first insulator layer is the first one in a direction from the anode toward the cathode,
ε₀ is permittivity of a vacuum,
S is a facing area of the anode and the cathode,
n is a number of the at least two insulator layers thus stacked, and
dₖ is a thickness of the k-th insulator layer when the first insulator layer is the first one in the direction from the anode toward the cathode.

With the fifth aspect, the capacitor (1) can have particularly increased capacitance at a measurement frequency of 100 Hz.

In a capacitor (1) of a sixth aspect of the present disclosure referring to any one of the first to fifth aspects, the at least one semiconductor layer (22) contains ZnO.

With the sixth aspect, the capacitor (1) can have particularly increased capacitance.

In a capacitor (1) of a seventh aspect of the present disclosure referring to any one of the first to sixth aspects, at least one of the anode (3) or the cathode (4) contains at least one of Ti, Pt, or Al.

With the seventh aspect, the capacitor (1) can have increased capacitance.

In a capacitor (1) of an eighth aspect of the present disclosure referring to any one of the first to seventh aspects, the anode (3) contains Al, and the cathode (4) contains a conductive polymer.

With the eighth aspect, the capacitor (1) is applicable to the conductive polymer aluminum electrolytic capacitor.

### REFERENCE SIGNS LIST

1 Capacitor
2 Multilayer Film
3 Anode
4 Cathode
21 Insulator Layer
22 Semiconductor Layer
31 Micro Pore
211 First Insulator Layer
212 Second Insulator Layer

1. A capacitor comprising an anode, a multilayer film, and a cathode stacked in this order,
the multilayer film including at least two insulator layers and at least one semiconductor layer,
the at least two insulator layers and the at least one semiconductor layer being alternately stacked,
the at least two insulator layers including a first insulator layer in contact with the anode and a second insulator layer in contact with the cathode,
the second insulator layer having a thickness less than a thickness of the first insulator layer.

2. The capacitor of claim 1, wherein
at least one of the at least two insulator layers contains Al₂O₃.

3. The capacitor of claim 1, wherein
the second insulator layer has a thickness greater than or equal to 2.5 nm and less than or equal to 18.0 nm.

4. The capacitor of claim 1, wherein
the at least two insulator layers consist of the first insulator layer and the second insulator layer.

5. The capacitor of claim 1, wherein
capacitance between the anode and the cathode at a measurement frequency of 100 Hz is higher than a theoretical value of series capacitance of the at least two insulator layers represented by Formula (1):
$$1 / C = {\sum }_{k = 1}^{n} ( 1 / ( \frac{{ε}_{k} {ε}_{0} S}{{d}_{k}} ) ) . \qquad ( 1 )$$
where
C is the theoretical value of the series capacitance,
εₖ is relative permittivity of a k-th insulator layer in a direction from the anode toward the cathode when the first insulator layer is the first,
ε₀ is permittivity of a vacuum,
S is a facing area of the anode and the cathode,
n is a number of the at least two insulator layers thus stacked, and
dₖ is a thickness of the k-th insulator layer in the direction from the anode toward the cathode when the first insulator layer is the first.

6. The capacitor of claim 1, wherein
the at least one semiconductor layer contains ZnO.

7. The capacitor of claim 1, wherein
at least one of the anode or the cathode contains at least one of Ti, Pt, or Al.

8. The capacitor of claim 1, wherein
the anode contains Al, and the cathode contains a conductive polymer.
